(19) United States
(12) Patent Application Publication
(10) Pub. No.: US 2026/0004209 A1
(43) Pub. Date: Jan. 1, 2026

(54) RECOMMENDATION ENGINE FOR SUGGESTING INTEGRATION PROCESSES USING ARTIFICIAL INTELLIGENCE

(71) Applicant: Boomi, LP, Conshohocken, PA (US)

(72) Inventors: Patricia B. MOORE, Richmond, VA (US); Swagata ASHWANI, San Francisco, CA (US); Aditi PAUL, Jersey City, NJ (US)

(73) Assignee: Boomi, LP, Conshohocken, PA (US)

(21) Appl. No.: 18/756,656

(22) Filed: Jun. 27, 2024

(51) Int. Cl. G06Q 10/0631; G06F 3/0486

(52) U.S. Cl. CPC G06Q 10/06315; G06F 3/0486

(57) ABSTRACT

A recommendation engine that utilizes artificial intelligence to suggest integration processes for an integration platform is disclosed. The recommendation engine may utilize clustering to identify and suggest pre-built integration processes that have been implemented by similarly situated organizations on an Integration Platform as a Service (iPaaS) platform. In addition, an explanation model may be used to generate an explanation for each suggested pre-built integration process. The suggestions and explanations, which may be automatically provided to a user, may be visually represented in a graphical user interface that allows a user to easily and immediately implement each suggested pre-built integration process on their own integration platform.

### BACKGROUND

### Field of the Invention

The embodiments described herein are generally directed to artificial intelligence, and, more particularly, to a recommendation engine for suggesting integration processes using artificial intelligence, and optionally, with explainability.

### Description of the Related Art

Integration Platform as a Service (iPaaS) enables the integration of applications and data. The iPaaS platform provided by Boomi® of Conshohocken, Pennsylvania, enables users to construct integration processes from pre-built steps, visually represented as “shapes,” which each has a set of configuration properties. Each step dictates how an integration process retrieves data, manipulates data, routes data, sends data, and/or the like. These steps can be connected together in endless combinations to build simple to very complex integration processes.

Recently, there has been a major push to simplify business processes. In particular, it is advantageous when workers can perform daily tasks without requiring special skills or training. This simplifies onboarding and empowers workers to be as efficient and productive as possible.

To this end, U.S. Pat. No. 11,886,965, issued on Jan. 30, 2024, describes artificial intelligence for suggesting shapes during the construction of an integration process. For example, the next shape to add to the integration process may be suggested, one at a time, until the integration process is complete.

However, what is still needed is artificial intelligence that is able to suggest an entire, pre-built integration process to be added to an organization's integration platform. In the state of the art, an iPaaS platform may comprise a recommendation engine that suggests integration processes to an organization based on software applications that the organization is using (e.g., Salesforce™). However, the state-of-the-art recommendation engine does not account for the fact that different organizations may utilize the same software application in different ways. Thus, the recommendation engine may suggest integration processes that are related to the software application, but irrelevant to the specific manner in which the particular organization utilizes the software application. In addition, state-of-the-art recommendation engines do not explain why a particular integration process is being suggested. Thus, state-of-the-art recommendation engines for integration processes, which are based on limited knowledge and generalized data, do not inspire confidence or trust and are of limited value. The present disclosure is directed to solving these and other problems discovered by the inventors.

### SUMMARY

Accordingly, systems, methods, and non-transitory computer-readable media are disclosed for a recommendation engine that suggests integration processes using artificial intelligence, and optionally, with explainability.

In an embodiment, a method comprises using at least one hardware processor to, in a recommendation process: retrieve organization-specific data for an organization, wherein the organization-specific data comprise integration data, representing one or more integration processes on an integration platform of the organization, and profile data, representing one or more attributes of the organization; derive an input feature vector from the organization-specific data, wherein the input feature vector comprises a value for each of a plurality of features; apply a recommendation engine to the input feature vector, wherein the recommendation engine determines at least one cluster of one or more other feature vectors, from among a plurality of clusters, to which the input feature vector is similar according to a similarity metric; identify one or more pre-built integration processes associated with the at least one cluster; and generate a screen of a graphical user interface, wherein the screen comprises a visual representation of each of the one or more pre-built integration processes, and wherein each visual representation is associated with an input for installing the respective pre-built integration process on the integration platform of the organization.

The method may further comprise using the at least one hardware processor to, in response to selection of the input for installing one of the one or more pre-built integration processes, redirect the graphical user interface to a screen comprising a virtual canvas on which shapes, representing components of the one pre-built integration process, are arranged according to a design of the one pre-built integration process, and wherein the shapes are configured to be dragged and dropped, so as to enable rearrangement of the components of the one pre-built integration process on the virtual canvas.

The method may further comprise using the at least one hardware processor to: retrieve global data for a plurality of organizations, wherein the global data comprise the integration data and the profile data for each of the plurality of organizations; derive a plurality of feature vectors from the global data, wherein each of the plurality of feature vectors comprises a value for each of the plurality of features; and group the plurality of feature vectors into the plurality of clusters using a clustering algorithm. The clustering algorithm may be a K-Means algorithm. The clustering algorithm may be a K-Prototype algorithm.

The method may further comprise using the at least one hardware processor to apply an explanation model to the input feature vector to produce an explanation for each of the one or more pre-built integration processes, wherein the screen further comprises, for each visual representation of one of the one or more pre-built integration processes, a visual representation of the explanation for the respective pre-built integration process. The explanation model may be a Local Interpretable Model-agnostic Explanations (LIME) model. The visual representation of each explanation may comprise a natural-language expression.

The plurality of features may comprise an indication of one or more data endpoints in the integration data, a size of the organization, a location of the organization, an industry of the organization, an indication of one or more trade associations to which the organization belongs, and/or an indication of one or more government agencies with which the organization interacts.

The recommendation process may be automatically executed when the screen is requested. The screen may be a homepage of the graphical user interface for an authenticated user.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for using artificial intelligence to recommend integration processes, according to an embodiment;

FIG. 4 illustrates a process for using artificial intelligence to recommend integration processes, according to an embodiment;

FIG. 5 illustrates a process for training a recommendation engine, according to an embodiment;

FIG. 6 illustrates a screen of a graphical user interface for suggesting integration processes, according to an embodiment; and

FIG. 7 illustrates a screen of a graphical user interface for configuring an integration process, according to an embodiment.

### DETAILED DESCRIPTION

In an embodiment, systems, methods, and non-transitory computer-readable media are disclosed for a recommendation engine that suggests integration processes using artificial intelligence, and optionally, with explainability. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

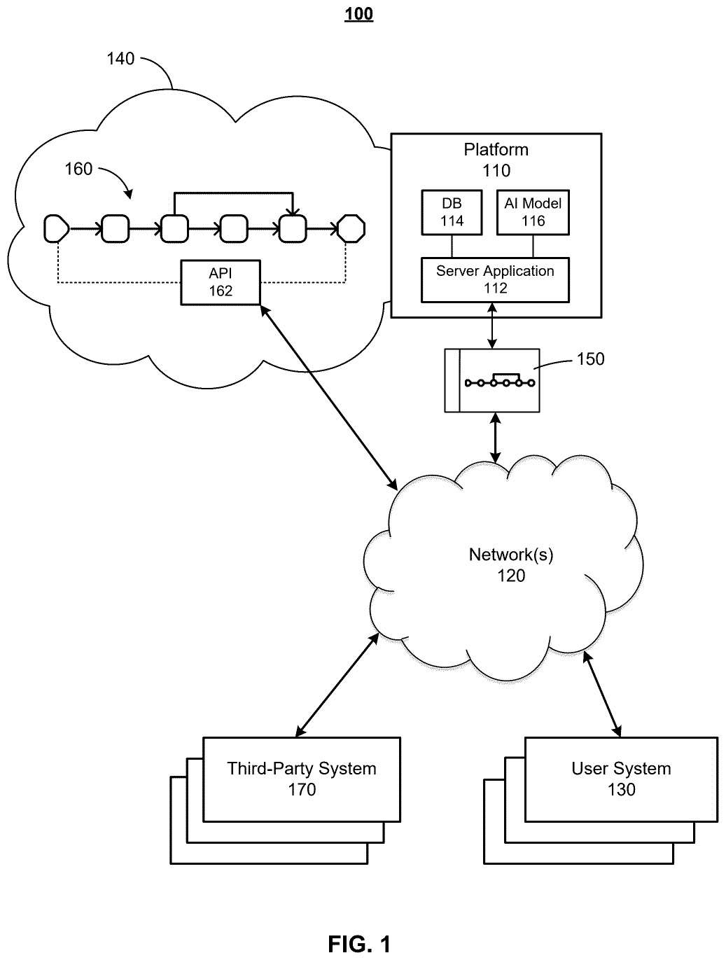

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. In particular, platform 110 may execute a server application 112, host a database 114 that may store data used by server application 112, and/or execute an artificial intelligence (AI) model 116 that may process data generated by server application 112 and/or stored in database 114 and/or generate data for use by server application 112 and/or storage in database 114. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and user system(s) 130. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 through a single set of network(s) 120, it should be understood that platform 110 may be connected to different user systems 130 via different sets of one or more networks. For example, platform 110 may be connected to a subset of user systems 130 via the Internet, but may be connected to another subset of user systems 130 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of an integration developer that has a user account for accessing server application 112 on platform 110. It should be understood that the integration developer may be anywhere from a novice, with little to no prior experience in integration development, to an expert, with many years of experience in integration development. When platform 110 is an iPaaS platform, each user account may be associated with an overarching organizational account for managing an integration platform on the iPaaS platform.

Server application 112 may manage an integration environment 140. In particular, server application 112 may provide a user interface 150 and backend functionality, including one or more of the processes disclosed herein, to enable users, via user systems 130, to construct, develop, modify, save, delete, test, deploy, un-deploy, and/or otherwise manage integration processes 160 within integration environment 140. User interface 150 may comprise a graphical user interface that implements a low-code environment, including potentially a no-code environment, in which users may construct integration processes 160.

The user of a user system 130 may authenticate with platform 110 using standard authentication means, to access server application 112 in accordance with permissions or roles of the associated user account. The user may then interact with server application 112 to manage one or more integration processes 160, for example, within a larger integration platform within integration environment 140. It should be understood that multiple users, on multiple user systems 130, may manage the same integration process(es) 160 and/or different integration processes 160 in this manner, according to the permissions or roles of their associated user accounts.

Although only a single integration process 160 is illustrated, it should be understood that, in reality, integration environment 140 may comprise any number of integration processes 160. In an embodiment, integration environment 140 supports integration platform as a service (iPaaS). In this case, integration environment 140 may comprise one or a plurality of integration platforms that each comprises one or a plurality of integration processes 160. Each integration platform may be associated with an organization, which may be associated with one or more user accounts by which respective user(s) manage the organization's integration platform, including the various integration process(es) 160.

An integration process 160 may represent a transaction involving the integration of data between two or more systems, and may comprise a series of elements that specify logic and transformation requirements for the data to be integrated. Each element, which may also be referred to herein as a “step” and have a visual representation referred to herein as a “shape,” may transform, route, and/or otherwise manipulate data to attain an end result from input data. For example, a basic integration process 160 may receive data from one or more data sources (e.g., via an application programming interface 162 of the integration process 160), manipulate the received data in a specified manner (e.g., including analyzing, normalizing, altering, updated, enhancing, transforming, and/or augmenting the received data), and send the manipulated data to one or more specified destinations (e.g., via an application programming interface of each destination). An integration process 160 may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

The functionality of server application 112 may include a process for constructing an integration process 160 within one or more screens of a graphical user interface of user interface 150. Embodiments of such functionality are disclosed, for example, in U.S. Pat. No. 8,533,661, issued on Sep. 10, 2013, and U.S. Pat. No. 11,886,965, issued on Jan. 30, 2024, which are both hereby incorporated herein by reference as if set forth in full, and referred to hereafter as “the GUI applications.” In particular, the GUI applications describe functionality that enable the construction of integration processes 160 on a virtual canvas.

Of particular relevance to disclosed embodiments, server application 112, in combination with AI model 116, may implement a recommendation engine that suggests one or more integration processes 160 to an organization. In particular, server 112 may execute a recommendation engine of AI model 116 to suggest one or more suggested pre-built integration process(es) 160, which have not yet been incorporated into the organization's integration platform. These suggested and pre-built integration process(es) 160 may be provided to a user for that organization, within one or more screens of the graphical user interface of user interface 150. For instance, the suggested integration process(es) 160 may be provided as tiles on a homepage (e.g., dashboard) or other webpage, after the user has authenticated with (e.g., signed in to) server application 112. Each tile may comprise one or more inputs for installing the respective integration process 160 on the organization's integration platform in integration environment 140. When the input for a given tile is selected, the graphical user interface may be redirected to a screen comprising a virtual canvas, which is pre-loaded with a visual representation (e.g., an arrangement of connected shapes) of the selected integration process 160, as well as one or more inputs for modifying or otherwise configuring (e.g., adding or deleting shapes, rearranging shapes, changing the parameters of a step, etc.), analyzing, testing, saving, and/or deploying the integration process 160, and/or the like.

Each integration process 160, when deployed, may be communicatively coupled to network(s) 120. For example, each integration process 160 may comprise an application programming interface (API) 162 that enables clients to access integration process 160 via network(s) 120. A client may push data to integration process 160 through application programming interface 162, and/or pull data from integration process 160 through application programming interface 162.

One or more third-party systems 170 may be communicatively connected to network(s) 120, such that each third-party system 170 may communicate with an integration process 160 in integration environment 140 via application programming interface 162. Third-party system 170 may host and/or execute a software application that pushes data to integration process 160 and/or pulls data from integration process 160, via application programming interface 162. Additionally or alternatively, an integration process 160 may push data to a software application on third-party system 170 and/or pull data from a software application on third-party system 170, via an application programming interface of the third-party system 170. Thus, third-party system 170 may be a client or consumer of one or more integration processes 160, a data source for one or more integration processes 160, and/or the like. As examples, the software application on third-party system 170 may comprise, without limitation, enterprise resource planning (ERP) software, customer relationship management (CRM) software, accounting software, and/or the like.

### 2. Example Processing System

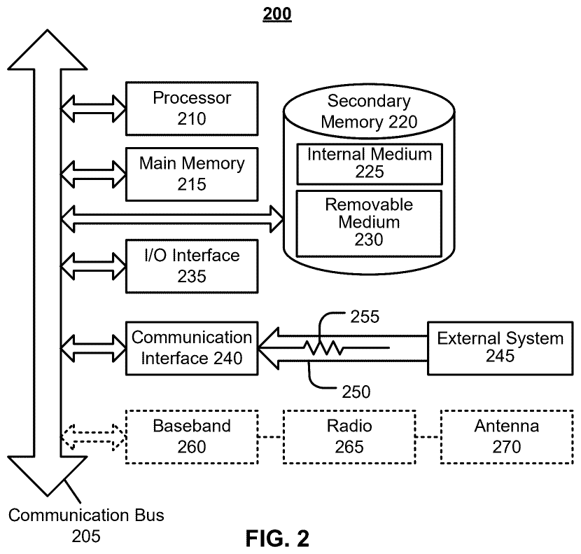

FIG. 2 illustrates an example processing system, by which one or more of the processes described herein may be executed, according to an embodiment. For example, system 200 may be used to store and/or execute server application 112 and/or AI model 116, host database 114, and/or may represent components of platform 110, user system(s) 130, third-party system 170, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Introduction

Currently, when a user signs into the Boomi® iPaaS platform, the user is directed to a homepage that comprises one or more tiles, representing suggested integration processes 160. In an actual implementation, a predefined number (e.g., five) of the tiles are always provided. Each tile represents a pre-built integration process 160, which may be referred to herein as a “recipe.” A user may select an input associated with each tile to initiate a process for installing the respective integration process 160 on the integration platform managed by the user.

The goal of suggesting integration processes 160 on users' homepages is to encourage those users to explore and discover potential improvements to their integration platforms and business workflows. This may accelerate new business growth and reduce the time to value for increased business efficiency and productivity. However, there remains room for improvement in terms of tailoring the suggestions to each particular user. In addition, the state of the art does not explain the reason for each suggestion.

Accordingly, disclosed embodiments utilize an AI-based recommendation engine to tailor suggestions of pre-built integration processes 160 to each specific user, based on a set of relevant features, which may be derived from integration and profile data. The recommendation engine may utilize ensemble clustering of the features for a plurality of organizations that utilize platform 110. By grouping the features into clusters, the recommendation engine is able to recognize patterns in the data and generate suggestions of pre-built integration processes 160 for users based on those patterns. In addition, an explanation model may be executed to explain each suggestion output by the recommendation engine, and particularly, explain the reason for suggesting each pre-built integration process 160. The suggestions and the explanations may be provided to each user, via the graphical user interface of user interface 150, in a manner that enables the user to easily initiate a process of installing (e.g., configuring and deploying) any pre-built integration process 160 that was suggested.

Thus, pre-built integration processes 160 are suggested based on, and essentially crowd-sourced from, peer organizations' integration platforms, and optionally, provided along with explanations for each suggestion. The assumption is that, for a given organization, integration processes 160 that are being used by similarly situated organizations will be of value to that organization.

Disclosed embodiments may suggest and explain complete end-to-end integration solutions that have been implemented by similar organizations. The combination of suggesting pre-built designs and explaining those suggestions may increase users' confidence that they are making safe decisions on what integration processes 160 to implement in their own integration platforms. In addition, disclosed embodiments may help accelerate platform adoption and increase users' confidence in their return on investment. Furthermore, suggesting integration processes 160 based on actual data usage within integration environment 140 and aligning that actual data usage with organization-specific data may help an operator of platform 110 to upsell additional services to its customer organizations with pre-built integration processes 160 for use cases that are more likely to resonate with those customer organizations' pain points, regardless of whether those pain points are ever expressed to the operator.

### 4. Data Flow

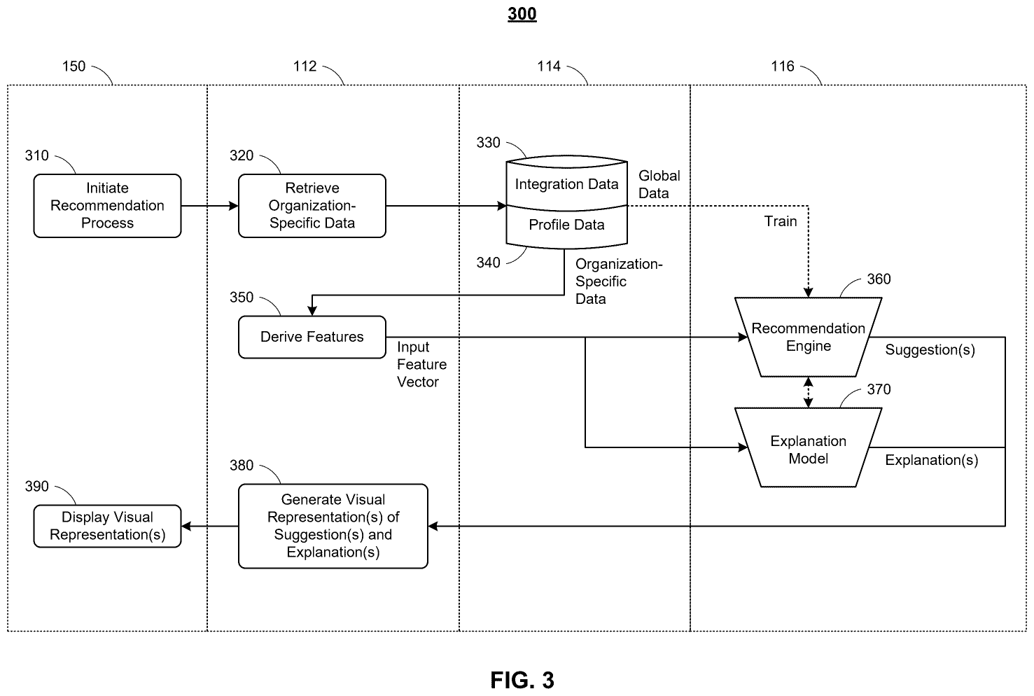

FIG. 3 illustrates an example data flow 300 for using artificial intelligence to recommend integration processes 160, according to an embodiment. In data flow 300, user interface 150 may implement modules 310 and 390, server application 112 may implement modules 320, 350, and 380, database 114 may store integration data 330 and profile data 340, and AI model 116 may comprise recommendation engine 360 and explanation model 370. Modules 310, 320, 350, 360, 370, 380, and 390 are preferably implemented as software modules, but could also be implemented as hardware modules or as modules comprising a combination of hardware and software.

Initially, module 310 of user interface 150 may initiate the recommendation process by triggering module 320. Module 310 may be executed automatically during generation of a screen of a graphical user interface of user interface 150. For example, module 310 may be executed automatically during generation of the homepage that is displayed immediately after a user signs in to the user's account or otherwise authenticates with server application 112 and/or to which the user can navigate during a session within the graphical user interface. Alternatively or additionally, module 310 may be executed during generation of another screen of the graphical user interface, and/or in response to a user operation, such as a selection of one or more inputs within the graphical user interface of user interface 150.

Once triggered, module 320 may retrieve organization-specific data for the user's organization from database 114. The organization-specific data may comprise integration data 330 for the organization and profile data 340 for the organization. Integration data 330 may comprise representations of the integration processes 160 that are implemented on the integration platform of the organization. Each representation of an integration process 160 may indicate the steps and connections within the integration process 160, comprise the configuration of each step, comprise metadata for the integration process 160, and/or the like. Profile data 340 may comprise a profile of the organization. The profile of the organization may comprise the value of one or more attributes of the organization, including firmographic attributes, such as the size of the organization, the location of the organization, the industry of the organization, and/or the like. The profile data 340 for an organization may also comprise related information about the organization, such as information about trade associations to which the organization belongs or which are otherwise relevant to the organization, government agencies with which the organization interacts (e.g., reports to) or which are otherwise relevant to the organization, news about the organization or relevant to the organization, government and/or industry regulations that apply to the organization, and/or the like. The organization-specific data, retrieved by module 320, may be input to module 350.

Module 350 may derive the value(s) of one or more, and generally a plurality of, features from the organization-specific data, which includes the portions of integration data 330 and profile data 340 associated with the user's organization. The features represent the input data that will be used by recommendation engine 360 to produce suggestions. Thus, it should be understood that the features should be relevant to the recommendation process. The value of each feature may be extracted, computed, or otherwise derived from the organization-specific data. Module 350 may format the value(s) of the feature(s) into an input feature vector that comprises or consists of a list of feature values. The features, whose values are listed within the input feature vector, as well as the order of those features, may be fixed across all iterations of module 350. Thus, every input feature vector will comprise values for the same features in the same order. Each feature represents a dimension of potential similarity.

The organization-specific integration data 330 represent what the user's organization is already doing within its integration platform. In an embodiment, the features that are derived from the organization-specific integration data 330 comprise an indication of one or more data endpoints used by the organization's integration platform, an indication of the order of steps (e.g., Start-SalesForce™ Connector-Map Step-NetSuite™ Connector-Stop) in one or more integration processes 160 in the organization's integration platform, the number of components (e.g., total number of components, average or mean number of components, median number of components, etc.) within one or more integration processes 160 in the organization's integration platform, and/or the like. Each data endpoint may represent a data source or data destination that is present in an integration process 160 in the organization's integration platform. A data source or destination may be another integration process 160, a third-party application (e.g., Salesforce™, NetSuite™, SAP™, Workday™, etc.) within the organization's integration platform or on a third-party system 170, or the like. The input feature vector may comprise a one-hot encoding for all potential data endpoints (e.g., “1” for the existence of the data endpoint in the organization-specific integration data 330, and “0” for the absence of the data endpoint in the organization-specific integration data 330).

The organization-specific profile data 340 represent the business of the user's organization itself. In an embodiment, the features that are derived from the organization-specific profile data 340 comprise a location of the organization, the size of the organization, the industry of the organization, trade associations to which the organization belongs, government agencies with which the organization interact (e.g., to which the organization must report), and/or the like. The location of the organization may be represented as one of a plurality of enumerated geographic regions. As one example, the enumerated geographical regions may comprise standard business region acronyms, such as AMER (i.e., North, Central, and South America), APAC (i.e., Asia and Pacific), and EMEA (i.e., Europe, the Middle East, and Africa). In an alternative embodiment, the enumerated geographical regions may be represented at a more granular level (e.g., continent, country, state or province, city, etc.). The size of the organization may be represented as a specific number or as one of a plurality of enumerated sizes. The size of the organization may be in terms of the number of employees, number of customers, amount of revenue, and/or the like. As one example that uses a plurality of enumerated sizes, the enumerated sizes may comprise ranges of numerical sizes in terms of employee count (e.g., 0-50 employees, 51-100 employees, 101-500 employees, etc.), customer count (e.g., 0-10,000 customers, 10,001 to 100,000 customers, 100,001 to 500,000 customers, etc.), annual revenue (e.g., $0 to $1 million in revenue, $1 million to $5 million in revenue, $5 million to $10 million in revenue, etc.), and/or the like. As another example, the enumerated sizes may comprise size classifications, such as commercial or enterprise. The industry of the organization may be represented as one of a plurality of enumerated industry classifications, such as retail, manufacturing, healthcare, legal, and the like. The input feature vector may also comprise a one-hot encoding for all potential trade associations and/or government agencies (e.g., “1” for the relevance of the trade association or government agency, and “0” for the irrelevance of the trade association or government agency).

Recommendation engine 360 may be applied to the input feature vector, output by module 350, to identify one or more pre-built integration processes 160 to suggest to the user. In particular, recommendation engine 360 may comprise a plurality of clusters of feature vectors. Recommendation engine 360 may determine at least one of the plurality of clusters to which the input feature vector is most similar according to a similarity metric. Any suitable similarity metric may be used. As an example, the similarity metric may be a distance, such as Euclidean distance, Manhattan distance, Cosine distance, Hamming distance, Minkowski distance, Chebyshev distance, Jaccard distance, Haversine distance, Sorensen-Dice distance, or the like, between the set of feature values in the input feature vector and the sets of features values in the clusters. Once the most similar cluster(s) are determined, recommendation engine 360 may identify one or more pre-built integration processes 160 associated with those determined cluster(s). In particular, each cluster or each feature vector may be associated with at least one pre-built integration process 160. Thus, the pre-built integration process(es) 160 that are identified may include those integration process(es) that are associated with each determined cluster and/or each feature vector within a determined cluster.

In an embodiment, recommendation engine 360 outputs a predefined number of pre-built integration processes 160. For example, recommendation engine 360 may output five pre-built integration processes 160 per execution. It should be understood that five is just an example, and that recommendation engine 360 may output any predefined number of pre-built integration processes 160 per execution, including one, two, three, four, six, seven, eight, nine, ten, or more. Recommendation engine 360 may select the predefined number of pre-built integration processes 160 by ranking at least a subset of the plurality of clusters according to their similarity metrics with the input feature vector and selecting the pre-built integration processes 160 associated with the top predefined number of ranked clusters, ranking at least a subset of feature vectors in the most similar cluster or clusters according to their similarity metrics with the input feature vector and selecting the pre-built integration processes 160 associated with the top predefined number of ranked feature vectors, ranking at least a subset of all feature vectors according to their similarity metrics with the input feature vector and selecting the pre-built integration processes 160 associated with the top predefined number of ranked feature vectors, and/or the like.

The plurality of clusters of feature vectors, searched by recommendation engine 360, may be generated using any suitable clustering algorithm. For example, to build the plurality of clusters, server application 112 may retrieve global data for a plurality of organizations, derive a plurality of feature vectors from the global data, and group the plurality of feature vectors into the plurality of clusters using a clustering algorithm. The global data may comprise integration data 330 and profile data 340 for each of the plurality of organizations. It should be understood that each of the plurality of feature vectors, derived from the global data, may comprise a value for each of the same features that were used for the input feature vector, derived by module 350, and in the same order.

The plurality of feature vectors may be grouped into the plurality of clusters according to any suitable clustering algorithm, using supervised or unsupervised learning. In an embodiment, the clustering algorithm is the K-Means algorithm, which is described in Lloyd, S., “Least squares quantization in PCM,” IEEE Transactions on Information Theory, 28 (2): 129-137, doi: 10.1109/TIT.1982.1056489, which is hereby incorporated herein by reference as if set forth in full. The K-Means algorithm groups feature vectors together based on their similarities in distance to the centroids of respective clusters, while attempting to minimize the sum of squared distances between each feature vector and the centroid of its assigned cluster. In a preferred embodiment, the clustering algorithm is the K-Prototype algorithm. The K-Prototype algorithm is an extension of the K-Means algorithm that is specifically designed to cluster mixed data types, including integers, real numbers, categories, strings, and/or the like. Thus, the K-Prototype algorithm is well suited to cluster feature vectors that comprise both numerical features (e.g., size of the organization, data endpoints, etc.) and categorical features (e.g., location of the organization, industry of the organization, etc.). The K-Prototype algorithm was introduced in Huang, Z., “Clustering large data sets with mixed numeric and categorical values,” Proceedings of the First Pacific Asia Knowledge Discovery and Data Mining Conference, Singapore, pp. 21-34, 1997, which is hereby incorporated herein by reference as if set forth in full. Examples of other suitable clustering algorithms include, without limitation, the K-Modes algorithm (e.g., suitable for feature vectors that consist of only categorical features), the Density-Based Spatial Clustering of Applications with Noise (DBSCAN) algorithm, the Gaussian Mixture Model (GMM) algorithm, the Balanced Iterative Reducing and Clustering using Hierarchies (BIRCH) algorithm, the Affinity Propagation clustering algorithm, the Mean-Shift clustering algorithm, the Ordering Points to Identify the Clustering Structure (OPTICS) algorithm, the Agglomerative Hierarchy clustering algorithm, and the like, including variations and extensions of any of these algorithms.

The integration data 330 used in the global data may be collected from a plurality of integration platforms managed and executed by a plurality of organizations, on an iPaaS platform, such as the Boomi® iPaaS platform. The iPaaS platform may support a plurality of integration platforms, each managed by a different organizational account that is associated with one or more user accounts. In this case, integration data 330 may represent a massive repository of previously executed integration processes 160 that is very diverse in terms of structures, configurations, applications, inputs and outputs, and the like, and potentially crowd-sourced from a diverse group of organizations (e.g., different sizes, different locations, different industries, etc.). In addition, the profile data 340 used in the global data may be collected for this same plurality of organizations. It should be understood that integration data 330 and profile data 340 may be cross-referenced within database 114, such that the integration data 330 for a particular organization is associated with the profile data 340 for that particular organization.

In an embodiment, a single input feature vector is derived for the user's organization and input into recommendation engine 360, to be matched to one or more clusters, which produces one or more suggested pre-built integration processes 160. In an alternative embodiment, a plurality of input feature vectors may be derived for the user's organization and input into recommendation engine 360. In this case, the values of any features derived from profile data 340 may be the same in each of the plurality of input feature vectors. However, the values of features derived from integration data 330 may differ across each of the plurality of input feature vectors. For example, each of at least a subset of integration processes 160 within the integration data 330 for the organization may be converted into a set of feature values, including, for example, an indication of each data endpoint in the respective integration process 160, the order of steps in the respective integration process 160, the number of components in the respective integration process 160, and/or the like. In other words, each of the plurality of input feature vectors may represent the same organization but different integration processes 160 implemented by that organization. Recommendation engine 360 may determine at least one of the plurality of clusters that is most similar to each of the plurality of input feature vectors or the set of all input feature vectors, according to the similarity metric, and then identify one or more integration processes 160 to suggest based on those cluster(s), in the same manner as discussed elsewhere herein.

In an embodiment, an explanation model 370 is also applied to the input feature vector(s), output by module 350, to produce an explanation for each of the pre-built integration process(es) 160 in the output of recommendation engine 360. Each explanation can be used to explain why the respective pre-built integration process 160 was output by recommendation engine 360. In particular, the explanation may indicate the contribution (e.g., percentage contribution) of each of the plurality of features to the output of recommendation engine 360. The subset of one or more features, from among the plurality of features, that contributed the most to the output, essentially explains why the associated pre-built integration process 160 was suggested by recommendation engine 360.

In an embodiment, explanation model 370 comprises or consists of the Local Interpretable Model-agnostic Explanations (LIME) model, which is described in Ribeiro, M. et al., “Model-Agnostic Interpretability of Machine Learning,” arXiv: 1606.05386v1, 2016, which is hereby incorporated herein by reference as if set forth in full. The LIME model may produce explanations based on inputs to recommendation engine 360 and their corresponding outputs from recommendation engine 360. In particular, the LIME model perturbs each input feature vector by changing the value of one or more features to produce a plurality of perturbed feature vectors, inputs each of a plurality of perturbed feature vectors into recommendation engine 360, and observes the changes in the output of recommendation engine 360 with each perturbation. From these observations, the LIME model is able to approximate recommendation engine 360 with an interpretable model (e.g., linear model), to produce an explanation of how the original input feature vector produced the output of recommendation engine 360. In producing the explanation, the LIME model may weight each perturbed input feature vector according to its similarity to the original input feature vector. The explanation, output by the LIME model, may be a contribution value for each of the plurality of features, such as the percentage that each feature contributed to the output of recommendation engine 360. Another suitable example of explanation model 370 is the Shapley Additive Explanations (SHAP) model, which is described in Lundberg, S. et al., “A unified approach to interpreting model predictions,” Advances in Neural Information Processing Systems, 2017, which is hereby incorporated herein by reference as if set forth in full. Both the LIME model and the SHAP model are model-agnostic, such that they can be trained regardless of the particular model that is used for recommendation engine 360. In an alternative embodiment that does not provide explanations, explanation model 370 may be omitted.

The suggested pre-built integration process (cs) 160, output by recommendation engine 360, and, in an embodiment that includes explanation model 370, the explanation(s) for each suggested pre-built integration process 160, output by explanation model 370, are provided to module 380. Module 380 generates a visual representation of each suggested pre-built integration process 160 and/or each explanation for each suggested pre-built integration process 160. As described elsewhere herein, the visual representation of each suggested pre-built integration process 160 may comprise a tile that describes the pre-built integration process 160, and an input for installing the pre-built integration process 160 on the integration platform being managed by the user.

The visual representation of each explanation may comprise a natural-language expression. As used herein, the terms “natural language” and “natural-language” refer to language, including grammar, that would be expected in a normal conversation between two humans. In an embodiment, the natural-language expression is automatically generated using a generative language model, which may be comprised in AI model 116. In particular, module 380 may generate a prompt using the explanation(s) output by explanation model 370, for example, by inserting each explanation, which may comprise a list of contribution values for each of the plurality of features or a subset of the plurality of features having the highest contribution values, into a predefined template. The predefined template may comprise a pre-conversation and/or post-conversation, which provide context and/or instructions for the generative language model, and a placeholder into which the explanation is inserted. The pre-conversation and/or post-conversation may define the role of the generative language model (e.g., to summarize the explanation), define an output format for the generative language model (e.g., a list structure, a hierarchical structure, a markup-language structure, etc.), and/or the like.

Module 380 may input the generated prompt to the generative language model to produce an output, which may comprise a natural-language expression, a data structure representing a visual dialog to be rendered in user interface 150, and/or the like. The generative language model may comprise or consist of a large language model, such as the Generative Pre-trained Transformer (GPT). GPT-4 is the fourth-generation language prediction model in the GPT-n series, created by OpenAI™ of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models. Examples of other suitable large language models include, without limitation, the Claude family of large language models (e.g., Claude 3 Opus) developed by Anthropic PBC of San Francisco, California, the Falcon large language model (e.g., Falcon 180B) released by the United Arab Emirates' Technology Innovation Institute (TII), the Large Language Model Meta AI (LLaMA) model (e.g., LLAMA 2) released by Meta AI of New York, New York, or the like. Alternatively or additionally, the generative language model may comprise or consist of a code-completion model that is trained to produce data structures, such as visual dialogs, to be rendered in a graphical user interface. In an embodiment, a pre-trained generative language model is used as a base model that is trained with few shot learning for the specific task of explaining the reason for the suggestion of a pre-built integration process 160 based on contributing features, to produce the generative language model.

Once the visual representation(s) of the suggestion(s) and/or explanation(s) have been generated, module 390 may display those visual representation(s) within the graphical user interface of user interface 150. For example, the visual representation(s) may be displayed in a region of the screen whose generation automatically triggered the recommendation process in module 310. As discussed elsewhere herein, this screen may be the homepage of the graphical user interface for an authenticated user or another screen to which an authenticated user may navigate. In other words, module 390 may generate a screen of the graphical user interface, comprising a visual representation of each of the suggested pre-built integration process(es) 160 output by recommendation engine 360, and optionally, a visual representation of the explanation, for each of the suggested pre-built integration process(es) 160, output by explanation model 370.

In an embodiment, each visual representation of one of the suggested pre-built integration processes 160, within the graphical user interface, is associated with an input for installing the respective pre-built integration process 160 on the integration platform of the organization within integration environment 140. In response to the selection of one of these input(s) by a user, the user may be redirected to a screen comprising a virtual canvas on which shapes, representing components of the selected pre-built integration process 160, are arranged according to the design of that pre-built integration process 160. The shapes may be configured to be dragged and dropped, so as to enable rearrangement of the components of the pre-built integration process 160 on the virtual canvas, and selectable, so as to enable configuration of each component.

In an embodiment, after a first set of suggested pre-built integration process(es) 160 is recommended, the user may select an input to generate a new, second suggested set of pre-built integration processes 160. In other words, the user may re-execute module 310 to initiate a new recommendation process. In an embodiment in which recommendation engine 360 and/or explanation model 370 utilize inference, the second set of suggested pre-built integration process(es) 160 that is recommended may differ from the first set of pre-built integration process(es) 160 that were recommended. It should be understood that the user may continue to select the input to request new sets of recommendations. In this manner, a user may cycle through recommendations to explore and discover other possible integration processes 160 for their integration platform. Notably, all of these suggested integration processes 160 are pre-built, such that they can be easily installed by the user with minimal input, and have been used and tested by other organizations, such that the user can be confident that the resulting integration process 160 will operate as intended.

### 5. Operation

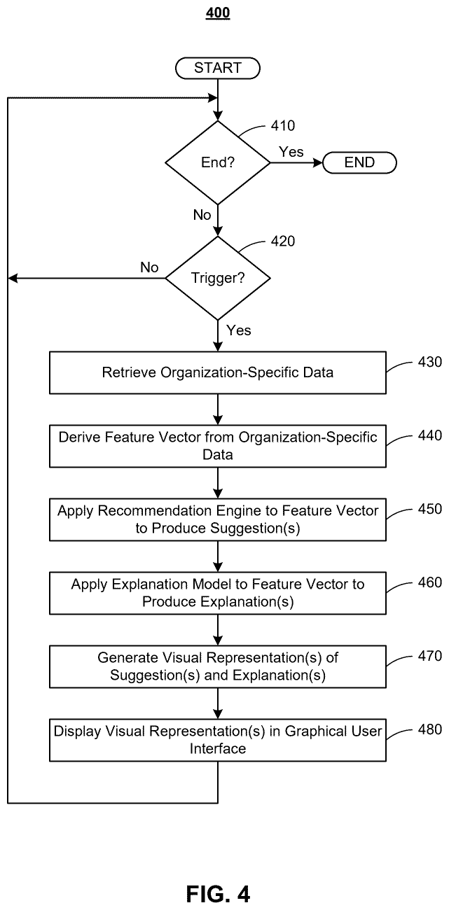

FIG. 4 illustrates a process 400 for using artificial intelligence to recommend integration processes 160, according to an embodiment. Process 400 may be implemented in server application 112. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

In subprocess 410, process 400 may determine whether or not to end. Process 400 may be operated as a service, such as a microservice, that provides recommendations to users of platform 110. Thus, process 400 may execute continuously until the service is terminated. In this case, process 400 may determine to end when the service has been terminated, and otherwise, not determine to end. When determining to end (i.e., “Yes” in subprocess 410), process 400 may end. Otherwise, when not determining to end (i.e., “No” in subprocess 410), process 400 may proceed to subprocess 420.

In subprocess 420, process 400 may determine whether or not the recommendation process has been triggered. As discussed elsewhere herein, the recommendation process may be initiated by module 310. For instance, the recommendation process may be automatically executed whenever a particular screen is requested. This screen may be a homepage of the graphical user interface for an authenticated user. The homepage may be automatically requested whenever a user signs in to or otherwise authenticates with server application 112. In addition, the authenticated user may navigate away from and back to the homepage one or more times during a session with server application 112. Alternatively or additionally, the screen may be a different webpage available during a session with server application 112. As another alternative or additional embodiment, the recommendation process may be manually triggered by a user operation, such as the selection of an input by an authenticated user within the graphical user interface. When the recommendation process has been triggered (i.e., “Yes” in subprocess 420), process 400 proceeds to subprocess 430. Otherwise, when the recommendation process has not been triggered (i.e., “No” in subprocess 420), process 400 may continue to wait for either the recommendation process to be triggered or process 400 to end.

In subprocess 430, organization-specific data for the organization, associated with the authenticated user, may be retrieved. The organization-specific data may comprise integration data 330, representing one or more integration processes 160 on the integration platform of the organization, and profile data 340, representing one or more attributes of the organization. Integration data 330 may comprise data and/or metadata for the organization's integration process(es) 160, including the components of the integration process(es) 160, the arrangement of those components, the data endpoints used by the integration process (cs) 160, one or more statistics about the integration process(es) 160, and/or the like. Profile data 340 may comprise a profile of the organization, including its size, location, industry, and/or the like, as well as related information, such as trade association(s) to which the organization belongs, government agency(ies) with which the organization interacts, news about the organization, government and/or industry regulations that apply to the organization, and/or the like.

In subprocess 440, an input feature vector may be derived from the organization-specific data. The feature vector may comprise a value for each of a plurality of features. The value for each feature may be extracted, computed, or otherwise derived from the organization-specific data. The plurality of features may comprise an indication (e.g., one-hot encoding) of one or more data endpoints in integration data 330, a size of the organization, a location of the organization, an industry of the organization, an indication (e.g., one-hot encoding) of one or more trade associations to which the organization belongs, an indication (e.g., one-hot encoding) of one or more government agencies with which the organization interacts, and/or the like.

In subprocess 450, recommendation engine 360 may be applied to the input feature vector. Recommendation engine 360 determines at least one cluster of one or more feature vectors, from among a plurality of clusters, to which the input feature vector is similar, according to a similarity metric. As discussed elsewhere herein, the similarity metric may comprise a distance between the input feature vector and each cluster. The distance may be measured between the input feature vector and a feature vector representing a centroid of the cluster, the closest feature vector within the cluster, the farthest feature vector in the cluster, or the like. In an embodiment that generates a plurality of input feature vectors for the organization (e.g., one feature vector for each integration process 160 represented in the organization-specific integration data 330), recommendation engine 360 may be applied to each of the plurality of input feature vectors to determine at least one cluster that is most similar to each of the plurality of input feature vectors.

In either case, recommendation engine 360 may identify one or more, including potentially all, of the feature vectors within the matching cluster(s), and then retrieve the identifier(s) of the pre-built integration process(es) 160 that are associated with each of these identified feature vectors. In other words, recommendation engine 360 identifies one or more pre-built integration processes 160 associated with the matching cluster(s). It should be understood that these identified pre-built integration process(es) 160 are what will be suggested to the user as recommendations.

In subprocess 460, explanation model 370 may be applied to each input feature vector to produce an explanation for each of the one or more pre-built integration processes 160 output by recommendation engine 360. The explanation model may comprise a LIME model. The LIME model may identify a contribution of each of at least a subset of the plurality of features to the output of recommendation engine 360 by generating a plurality of perturbed feature vectors by modifying the value of one or more features in the input feature vector, applying recommendation engine 360 to each perturbed feature vector, and observing the output of recommendation engine 360 for each perturbed feature vector. The output of explanation model 370 may be a list of contribution values (e.g., percentages) for each of at least a subset of the plurality of features represented by the input feature vector.

In subprocess 470, a visual representation of each of the pre-built integration process(es) 160, output by recommendation engine 360, may be generated. In addition, for each visual representation of one of these pre-built integration process(es) 160, a visual representation of the explanation, output by explanation model 370, may be generated. Each visual representation of an explanation may comprise a natural-language expression. As discussed elsewhere herein, the natural-language expression may be automatically and dynamically generated by generating a prompt that incorporates the explanation, output by explanation model 370, and inputting the prompt into a generative language model to produce a natural-language description of the contributing features in the explanation.

In subprocess 480, the visual representation(s) of the pre-built integration process(es) 160, output by recommendation engine 360, and/or the explanation(s), output by explanation model 370 for those pre-built integration process(es) 160, may be displayed in the graphical user interface. In particular, a screen of the graphical user interface may be generated to comprise the visual representation (e.g., a tile) of each of the pre-built integration process(es) 160 and, in an embodiment, for each visual representation of one of the pre-built integration process(es) 160, the visual representation of the explanation (e.g., natural-language expression) for that respective pre-built integration process 160.

Each visual representation of one of the pre-built integration process(es) 160, may comprise or otherwise be associated with an input for installing the respective pre-built integration process 160 on the integration platform of the organization associated with the authenticated user. In response to the selection of the input for installing one of the pre-built integration processes 160 by the user, user interface 150 may redirect the graphical user interface to a screen comprising a virtual canvas on which shapes, representing components of the selected pre-built integration process 160, are arranged according to the design of that pre-built integration process 160. Examples of such a screen, comprising a virtual canvas, are described in the GUI applications. The shapes are configured to be dragged and dropped, so as to enable rearrangement of the components of the pre-built integration process 160 on the virtual canvas. In summary, the user may easily explore integration processes 160 that other organizations have implemented and which are relevant to the integration platform that the user is managing, select an integration process 160 to install, immediately begin customizing or otherwise configuring the integration process 160 for the integration platform that the user is managing, and then deploy that integration process 160 to the integration platform that the user is managing, all with only a few inputs that even the most novice user can understand.

### 6. Training

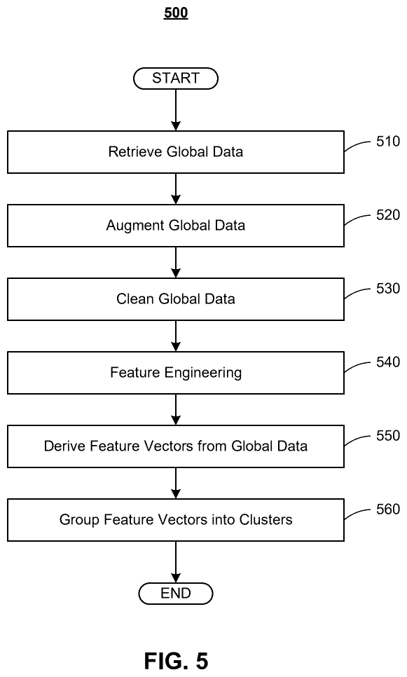

FIG. 5 illustrates a process 500 for training recommendation engine 360, according to an embodiment. Process 500 may be implemented in server application 112. While process 500 is illustrated with a certain arrangement and ordering of subprocesses, process 500 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Initially, in subprocess 510, global data for a plurality of organizations may be retrieved. The global data may comprise integration data 330, representing one or more integration process(es) 160 on the integration platform of an organization, and profile data 340, representing attributes of an organization, for each of the plurality of organizations. Integration data 330 may comprise data and/or metadata for each respective organization's integration process(es) 160, including the components of the integration process(es) 160, the arrangement of those components, the data endpoints used by the integration process(es) 160, one or more statistics about the integration process(es) 160, and/or the like. Profile data 340 may comprise a profile of the respective organization, including its size, location, industry, and/or the like, as well as related information, such as trade association(s) to which the organization belongs, government agency(ies) with which the organization interacts, news about the organization, government and/or industry regulations that are applicable to the organization, and/or the like.

It should be understood that the global data, retrieved in subprocess 510, may be the same data as retrieved in subprocess 430, but for a plurality of different organizations, as opposed to a single organization. The global data may be collected from a plurality of organizations that are each managing an integration platform within integration environment 140 of platform 110, which may be an iPaaS platform.

In subprocess 520, the global data may be augmented. For example, extrinsic data, relevant to each of the plurality of organizations, may be collected from one or more third-party data sources (e.g., on one or more third-party systems 170), such as news services, social media sites, websites for trade associations, government websites, and/or the like. For example, extrinsic data for a given organization may include news articles about the organization, social media posted by the organization, information about any trade associations to which the organization belongs, information about any government agencies with which the organization interacts, government and/or industry regulations that apply to the organization, and/or the like. These extrinsic data may be added to the global data, to thereby augment the available data for each of the plurality of organizations.

In subprocess 530, the global data may be cleaned. In particular, integration data 330, profile data 340, and/or the extrinsic data may be normalized, standardized, and/or otherwise cleaned. For instance, at least some attributes within profile data 340 may be specified by the organization, and different organizations may specify the attribute(s) in different formats. All of these various formats may be converted to a single standard format. In addition, missing values in the global data may be filled in. For example, in an embodiment, the extrinsic data may be used to fill in any missing values within the global data (e.g., in profile data 340).

In subprocess 540, feature engineering may be performed on the global data. Any suitable method for feature engineering may be used. In general, the global data may be analyzed to identify the set of features, derivable from the global data, that is most predictive of the similarity between organizations and/or their integration platforms. It should be understood that this set of the most relevant features may become the plurality of features whose values are included in each feature vector.

In subprocess 550, a plurality of feature vectors may be derived from the global data. Each of the plurality of feature vectors will comprise a value for each of the plurality of features that were deemed relevant by the feature engineering in subprocess 540. A feature vector may be derived for each of the plurality of organizations represented in the global data and/or for each integration process 160 represented in the global data.

In subprocess 560, the plurality of feature vectors may grouped into a plurality of clusters using a clustering algorithm. The clustering algorithm may be the K-Means algorithm (e.g., if the feature values are all numerical), the K-Modes algorithm (e.g., if the feature values are all categorical), or the K-Prototypes algorithm (e.g., if the feature values comprise both numerical and categorical values), or any other suitable clustering algorithm. The resulting clusters, output by subprocess 560, represent the clusters that are searched by recommendation engine 360 during the recommendation process.

### 7. Graphical User Interface

Disclosed embodiments provide a region on at least one screen of the graphical user interface that suggests pre-built integration processes 160 for implementation on an organization's integration platform within integration environment 140. As discussed elsewhere herein, these pre-built integration processes 160 are determined using recommendation engine 360, and explanations for each suggestion may be generated using explanation model 370. Each suggested pre-built integration process 160 may be associated with an input that redirects the graphical user interface to a screen, comprising a virtual canvas and a representation of the selected pre-built integration process 160, so that the user can immediately implement (e.g., configure and deploy) the pre-built integration process 160 on their organization's integration platform.

By using integration data 330 from previously implemented integration processes 160, as well as profile data 340 (e.g., each organization's size, location, industry, etc.), the suggestions may be better targeted to an organization's particular business needs, based on the organization's similarity to other organizations that have implemented the suggested integration processes 160. The suggestions will inherently evolve over time with evolving business regulations and trends that are relevant to the organization. As an example, in response to changes in the Health Insurance Portability and Accountability Act (HIPAA), organizations in the healthcare industry may utilize their domain expertise to change how they integrate HIPAA data. These changes will be reflected in their implemented integration processes 160, and therefore, in the integration processes 160 that are suggested to similar organizations in the healthcare industry, which may not have the same domain expertise. In other words, domain knowledge is effectively transferred between organizations via the disclosed recommendation process.

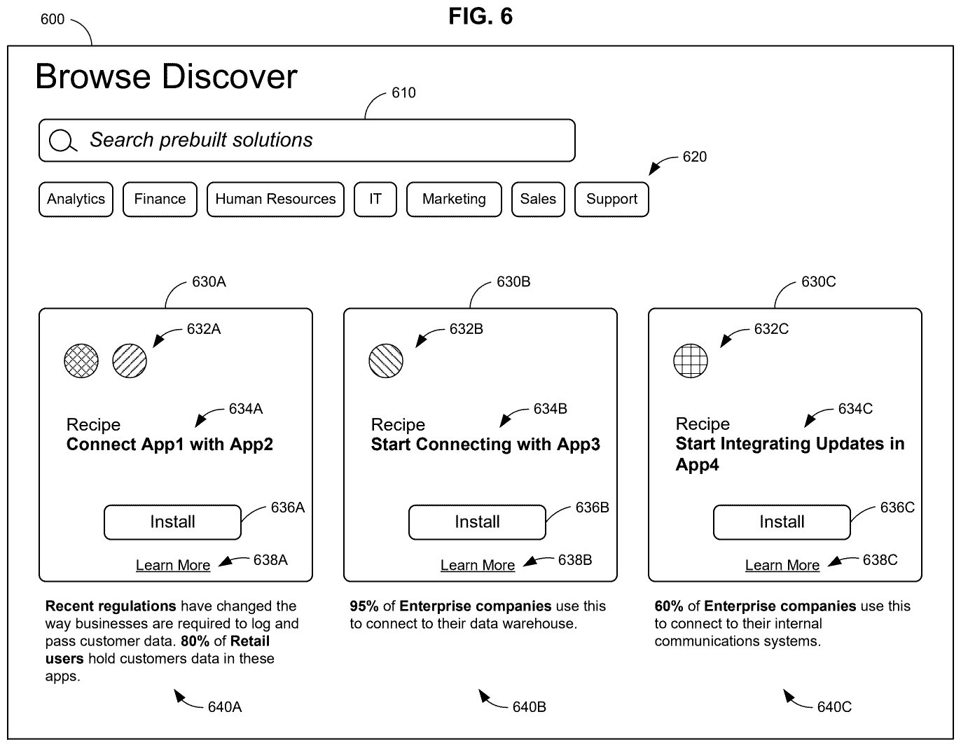

FIG. 6 illustrates a screen 600 of a graphical user interface for suggesting integration processes 160, according to an embodiment. The graphical user interface may be provided by user interface 150 of server application 112. Screen 600 may represent at least a portion of a homepage (e.g., a bottom portion of the homepage) that is provided to an authenticated user of server application 112. Alternatively, screen 600 may represent at least a portion of another screen to which an authenticated user of server application 112 is able to navigate during an authenticated session.

In the illustrated example, screen 600 comprises a search input 610, one or more suggested search terms 620, one or more tiles 630, and an explanatory statement 640 for each tile 630. It should be understood that each tile 630 is a visual representation of one pre-built integration process 160, and each explanatory statement 640 is a visual representation of an explanation, output by explanation model 370, for a corresponding one of the pre-built integration processes 160.

The user may input their own search terms into search input 610 and/or select one or more of the suggested search terms 620. When a user selects one of the suggested search terms 620, the selected search term 620 may be automatically input into search input 610 or immediately submitted as a search request. Regardless of whether the user inputs their own search terms or uses suggested search terms 620, the user may submit all of the search terms, input into search input 610, as a search request. In response to the search request, server application 112 may search for pre-built integration processes 160, represented in integration data 330, that match the submitted search terms, and visually represent matching pre-built integration processes 160 as tiles 630.

The generation of screen 600 may trigger module 310 (e.g., in subprocess 420) to initiate the recommendation process, which produces one or more suggested pre-built integration processes 160 with which to seed screen 600. Thus, as soon as screen 600 is displayed, even before the user performs a search within screen 600, one or more tiles 630 will be generated and provided within screen 600. This provides the user with the opportunity to discover relevant integration processes 160 without even having to perform a search, and allows the discovery of relevant integration processes 160 which a user may not have otherwise found if left to search for themselves.

The number of pre-built integration processes 160 that are initially displayed in screen 600 and/or in the results of any search may be limited to a predefined number. In the illustrated example, the predefined number is three. However, the predefined number may be any number, including one, two, four, five, six, seven, eight, nine, ten, or more. This predefined number may be a fixed system setting or a configurable user setting.

Once the user performs a search (i.e., submits a search request) within screen 600, existing tile(s) 630 may be replaced with tile(s) 630 representing pre-built integration processes 160 returned by the search. Each tile 630, whether representing pre-built integration processes 160 suggested by recommendation engine 360 or pre-built integration processes 160 returned in search results, may be identical in format. In the illustrated example, each tile 630 comprises one or more icons 632 related to the pre-built integration process 160 that is visually represented by the tile 630, an indication 634 of the pre-built integration process 160 that is visually represented by the tile 630, an input 636 for installing the pre-built integration process 160 that is visually represented by the tile 630, and/or an input 638 for learning more about the pre-built integration process 160 that is visually represented by the tile 630.

Each icon 632 may represent a data endpoint within the pre-built integration process 160 represented by the respective tile 630. An icon 632 may be added to tile 630 for each unique data endpoint that is included in the pre-built integration process 160. Thus, if pre-built integration process 160 consists of one unique data endpoint, tile 630 may consist of a single icon 632, if pre-built integration process 160 consists of two data endpoints, tile 630 may consist of two icons 632, and so on and so forth. If pre-built integration process 160 comprises a data endpoint that is a software application, the icon 632 representing the data endpoint may comprise a logo of that software application. For example, icons 632A of tile 630A may comprise or consist of the logos for App1 and App2, icon 632B of tile 630B may comprise or consist of the logo for App3, and icon 632C of tile 630C may comprise or consist of the logo for App4.

Each indication 634 may comprise a name, description, summary, and/or the like for the pre-built integration process 160 represented by the respective tile 630. For example, indication 634 may comprise a summary of the purpose of pre-built integration process 160. As illustrated, indication 634A of tile 630A describes the purpose of the respective pre-built integration process 160 as connecting App1 with App2, indication 634B of tile 630B describes the purpose of the respective pre-built integration process 160 as connecting to App3, and indication 634C of tile 630C describes the purpose of the respective pre-built integration process 160 as integrating updates in App4.

Each input 636, when selected, initiates an installation (e.g., configuration and deployment) of the pre-built integration process 160 represented by the respective tile 630. For example, when selected, input 636A of tile 630A may initiate installation of the pre-built integration process 160 represented by tile 630A, input 636B of tile 630B may initiate installation of the pre-built integration process 160 represented by tile 630B, and input 636C of tile 630C may initiate installation of the pre-built integration process 160 represented by tile 630C. Initiation of the installation of a pre-built integration process 160 may comprise redirecting the graphical user interface to another screen comprising a virtual canvas on which the pre-built integration process to be installed is visually represented as a plurality of connected shapes, which can be dragged and dropped and configured as needed, before deployment to the integration platform managed by the user.

Each input 638, when selected, may result in additional information about the pre-built integration process 160, represented by the respective tile 630, being displayed within the graphical user interface. This additional information may be displayed by redirecting the graphical user interface to a screen comprising details about the respective pre-built integration process 160, or by generating and displaying a dialog box over screen 600 that comprises details about the respective pre-built integration process 160. For example, when selected, input 638A of tile 630A may provide additional information about the pre-built integration process 160 represented by tile 630A, input 638B of tile 630B may provide additional information about the pre-built integration process 160 represented by tile 630B, and input 638C of tile 630C may provide additional information about the pre-built integration process 160 represented by tile 630C.

Each tile 630 may be associated with an explanatory statement 640. For example, tile 630A is associated with explanatory statement 640A, tile 630B is associated with explanatory statement 640B, and tile 630C is associated with explanatory statement 640C. Each explanatory statement 640 may be positioned near the associated tile 630, such that it is easily discernable as being associated with the associated tile 630. In the illustrated example, each explanatory statement 640 is positioned immediately below the associated tile 630. In an alternative embodiment, each explanatory statement 640 may be positioned above or be comprised within the associated tile 630.

It should be understood that each explanatory statement 640 is derived from the output of explanation model 370, as described elsewhere herein. As illustrated, explanatory statement 640 may comprise a natural-language expression that describes why the pre-built integration process 160, represented by the associated tile 630, was suggested to the user. For instance, explanatory statement 640A indicates that a pre-built integration process 160 connecting App1 with App2 was suggested due to a change in regulations concerning how customer data must be handled. As another example, an explanatory statement 640 could indicate that a pre-built integration process 160 was suggested because it was implemented by other organizations in the same location (e.g., same business region) that belong to the same industry (e.g., retail). Explanatory statement 640 may also relate the suggestion back to the user's organization, for example, by conveying the percentage of similar organizations (e.g., in the same customer segment) that utilized the pre-built integration process 160 represented by the associated tile 630. Each explanatory statement 640 may provide clear justifications for suggesting the respective pre-built integration process 160, which may improve the user's trust in and understanding of the recommendation process.

In an embodiment, suggested search terms 620 could be generated based on the recommendation process that is executed during generation of screen 600. For instance, suggested search terms 620 could be derived from the pre-built integration processes 160 that are output by recommendation engine 360. In particular, keywords may be extracted from these pre-built integration processes 160 and/or the metadata of these pre-built integration processes 160. As examples, suggested search terms 620 may include the names of data endpoints (e.g., names of software applications) within the pre-built integration processes 160, keywords in the descriptions of the pre-built integration processes 160, and/or the like. Keywords could also be derived from the profile data 340 for the organization or similar organizations. As examples, suggested search terms 620 may include the location of the organization, the industry of the organization, the name of a trade association to which the organization belongs, the name of a government agency with which the organization interacts, and/or the like. In other words, suggested search terms 620 may be seeded with keywords that are relevant to the user's organization.

Once a user submits a search request via screen 600, the recommendation process may no longer be used to regenerate or update screen 600. Rather, a search engine may be used in place of recommendation engine 360. Alternatively, the recommendation process may be used to influence the search results. For example, recommendation engine 360 could be used to narrow the search space for the search request by limiting the search space to one or more clusters that are most similar to the input feature vector(s) derived by module 350 for the organization.

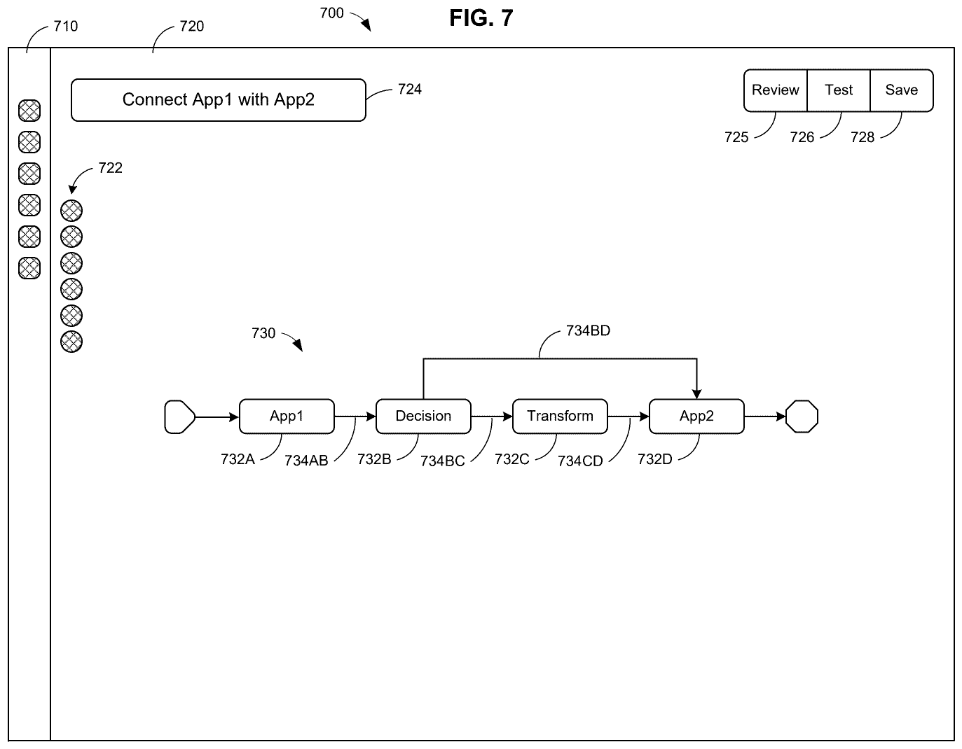

FIG. 7 illustrates a screen 700 of a graphical user interface for configuring an integration process 160, according to an embodiment. Again, the graphical user interface may be provided by user interface 150 of server application 112. Screen 700 may be the result of a user selecting input 636, within a tile 630, to install the pre-built integration process 160 represented by that tile 630. In response to the selection of input 636 by the user, the graphical user interface may be redirected from screen 600 to screen 700, so that the pre-built integration process 160 may be configured and modified, if necessary, before being deployed. In this particular example, the user has selected input 636A of tile 630A in screen 600.

Screen 700 may comprise a navigation bar 710 and a virtual canvas 720. Virtual canvas 720 starts out with a visual representation 730 of the pre-built integration process 160 corresponding to the tile 630 for which input 636 was selected to trigger the redirection to screen 700. Thus, in the illustrated example, visual representation 730 is of the pre-built integration process 160, represented by tile 630A in screen 600, whose purpose was described by indication 634A as connecting App1 with App2.

Virtual canvas 720 comprises a shape palette 722, from which new shapes can be dragged and dropped onto virtual canvas 720, and a header 724 which may comprise information (e.g., a default name which may be edited by the user) about the pre-built integration process 160 represented by visual representation 730 on virtual canvas 720. In addition, virtual canvas 720 may comprise a review input 725 for analyzing the pre-built integration process 160 represented on virtual canvas 720, a test input 726 for testing the pre-built integration process 160 represented on virtual canvas 720, and a save input 728 for saving the pre-built integration process 160 represented on virtual canvas 720.

Visual representation 730 of pre-built integration process 160 comprises shapes 732, which each represents a step within pre-built integration process 160, and which are connected by connections 734. For example, shape 732A represents a connector to the software application App1, which is a data endpoint within pre-built integration process 160, shape 732B represents a decision step which branches to shape 732C and shape 732D based on some determination logic, shape 732C represents a transformation step, and shape 732D represents a connector to the software application App2. Shape 732A is connected to shape 732B via connection 734AB, shape 732B is connected to shape 732C via connection 734BC and to shape 732D via connection 734BD, and shape 732C is connected to shape 732D via connection 734CD. It should be understood that this is just one simple example of an integration process 160 that has been provided for the sake of illustration, and that an actual integration process 160 may be simpler, as simple, more complex, or much more complex than the illustrated integration process 160.

The graphical user interface enables a user to drag and drop shapes 732 anywhere on virtual canvas 720. In addition, the graphical user interface enables a user to drag and drop new shapes 732 from shape palette 722 to anywhere on virtual canvas 720. Once a shape 732 is positioned on virtual canvas 720, the user may draw a connection 734 from that shape 732 to any other shape 732 on virtual canvas 720, to thereby create a data flow between the steps represented by those shapes 732. Thus, while virtual canvas 720 will initially comprise a visual representation 730 that is configured according to the design of the pre-built integration process 160 that was represented by the tile 630 whose corresponding input 636 was selected from screen 600, the user may rearrange shapes 732 and/or connections 734, add new shapes 732 and/or connections 734, and/or otherwise modify or reconfigure visual representation 730, to produce a modified and/or customized integration process 160. The user may also analyze, test, and/or save and/or deploy the integration process 160 that is visually represented by visual representation 730 on virtual canvas 720, using the respective inputs 725, 726, and 728.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, in a recommendation process:
retrieve organization-specific data for an organization, wherein the organization-specific data comprise integration data, representing one or more integration processes on an integration platform of the organization, and profile data, representing one or more attributes of the organization;
derive an input feature vector from the organization-specific data, wherein the input feature vector comprises a value for each of a plurality of features;
apply a recommendation engine to the input feature vector, wherein the recommendation engine determines at least one cluster of one or more other feature vectors, from among a plurality of clusters, to which the input feature vector is similar according to a similarity metric;
identify one or more pre-built integration processes associated with the at least one cluster; and
generate a screen of a graphical user interface, wherein the screen comprises a visual representation of each of the one or more pre-built integration processes, and wherein each visual representation is associated with an input for installing the respective pre-built integration process on the integration platform of the organization.

2. The method of claim 1, wherein the method further comprises using the at least one hardware processor to, in response to selection of the input for installing one of the one or more pre-built integration processes, redirect the graphical user interface to a screen comprising a virtual canvas on which shapes, representing components of the one pre-built integration process, are arranged according to a design of the one pre-built integration process, and wherein the shapes are configured to be dragged and dropped, so as to enable rearrangement of the components of the one pre-built integration process on the virtual canvas.

3. The method of claim 1, further comprising using the at least one hardware processor to:
retrieve global data for a plurality of organizations, wherein the global data comprise the integration data and the profile data for each of the plurality of organizations;
derive a plurality of feature vectors from the global data, wherein each of the plurality of feature vectors comprises a value for each of the plurality of features; and
group the plurality of feature vectors into the plurality of clusters using a clustering algorithm.

4. The method of claim 3, wherein the clustering algorithm is a K-Means algorithm.

5. The method of claim 3, wherein the clustering algorithm is a K-Prototype algorithm.

6. The method of claim 1, further comprising using the at least one hardware processor to apply an explanation model to the input feature vector to produce an explanation for each of the one or more pre-built integration processes, wherein the screen further comprises, for each visual representation of one of the one or more pre-built integration processes, a visual representation of the explanation for the respective pre-built integration process.

7. The method of claim 6, wherein the explanation model is a Local Interpretable Model-agnostic Explanations (LIME) model.

8. The method of claim 6, wherein the visual representation of each explanation comprises a natural-language expression.

9. The method of claim 1, wherein the plurality of features comprises an indication of one or more data endpoints in the integration data.

10. The method of claim 1, wherein the plurality of features comprises a size of the organization.

11. The method of claim 1, wherein the plurality of features comprises a location of the organization.

12. The method of claim 1, wherein the plurality of features comprises an industry of the organization.

13. The method of claim 1, wherein the plurality of features comprise an indication of one or more trade associations to which the organization belongs.

14. The method of claim 1, wherein the plurality of features comprise an indication of one or more government agencies with which the organization interacts.

15. The method of claim 1, wherein the recommendation process is automatically executed when the screen is requested.

16. The method of claim 15, wherein the screen is a homepage of the graphical user interface for an authenticated user.

17. A system comprising:
at least one hardware processor; and
software that is configured to, when executed by the at least one hardware processor,
retrieve organization-specific data for an organization, wherein the organization-specific data comprise integration data, representing one or more integration processes on an integration platform of the organization, and profile data, representing one or more attributes of the organization,
derive an input feature vector from the organization-specific data, wherein the input feature vector comprises a value for each of a plurality of features,
apply a recommendation engine to the input feature vector, wherein the recommendation engine determines at least one cluster of one or more other feature vectors, from among a plurality of clusters, to which the input feature vector is similar according to a similarity metric,
identify one or more pre-built integration processes associated with the at least one cluster, and
generate a screen of a graphical user interface, wherein the screen comprises a visual representation of each of the one or more pre-built integration processes, and wherein each visual representation is associated with an input for installing the respective pre-built integration process on the integration platform of the organization.

18. A non-transitory computer-readable medium having instructions stored therein, wherein the instructions, when executed by a processor, cause the processor to:
retrieve organization-specific data for an organization, wherein the organization-specific data comprise integration data, representing one or more integration processes on an integration platform of the organization, and profile data, representing one or more attributes of the organization;
derive an input feature vector from the organization-specific data, wherein the input feature vector comprises a value for each of a plurality of features;
apply a recommendation engine to the input feature vector, wherein the recommendation engine determines at least one cluster of one or more other feature vectors, from among a plurality of clusters, to which the input feature vector is similar according to a similarity metric;
identify one or more pre-built integration processes associated with the at least one cluster; and
generate a screen of a graphical user interface, wherein the screen comprises a visual representation of each of the one or more pre-built integration processes, and wherein each visual representation is associated with an input for installing the respective pre-built integration process on the integration platform of the organization.
